(19) United States
(12) Patent Application Publication
(10) Pub. No.: US 2006/0267302 A1
(43) Pub. Date: Nov. 30, 2006

(54) Quick release device for hand cart

(75) Inventor: Gordon Liao, Yung Kang City (TW)

Correspondence Address: NIKOLAI & MERSEREAU, P.A., 900 SECOND AVENUE SOUTH, SUITE 820, MINNEAPOLIS, MN, 55402, US

(73) Assignee: Unique Product & Design Co. Ltd., Yung Kang City (TW)

(21) Appl. No.: 11/141,082

(22) Filed: May 31, 2005

(51) Int. Cl. B62B 5/00

(52) U.S. Cl. 280/47.34

(57) ABSTRACT

A hand cart includes a wheel frame, a transverse rod, a wheel, and a quick release device. The quick release device includes a locking member, a press button, an elastic member, and a cover. Thus, the locking member and the elastic member are made easily and conveniently, thereby decreasing costs of fabrication. In addition, the wheel axle of the wheel is mounted on and detached from the frame body of the wheel frame easily and rapidly.

### BACKGROUND OF THE INVENTION

1. Field of the Invention

The present invention relates to a quick release device, and more particularly to a quick release device for a hand controlled wheeled vehicle, such as a hand cart, stroller, golf cart and the like.

2. Description of the Related Art

A conventional hand cart in accordance with the prior art shown in FIGS. 7 and 8 comprises a wheel frame 2A having a frame body 20A formed with a mounting hole 21A and a fixing bore 24A, a transverse rod 22A having an end portion mounted in the mounting hole 21A of the frame body 20A of the wheel frame 2A and formed with a fixing hole 23A communicating with the fixing bore 24A of the frame body 20A, a wheel 3A having a wheel axle 31A mounted in the end portion of the transverse rod 22A and having an end portion formed with an annular locking groove 32A communicating with the fixing hole 23A of the transverse rod 22A, and a U-shaped elastic plate 1A mounted on the frame body 20A of the wheel frame 2A by a plurality of rivets 11A and having a first side provided with a locking pin 12A extended through the fixing bore 24A of the frame body 20A and the fixing hole 23A of the transverse rod 22A and detachably locked in the locking groove 32A of the wheel axle 31A to detachably lock the wheel axle 31A of the wheel 3A and the end portion of the transverse rod 22A on the frame body 20A of the wheel frame 2A.

When a user presses a second side 13A of the elastic plate 1A as shown in FIG. 8, the locking pin 12A is moved outward to detach from the locking groove 32A of the wheel axle 31A, thereby detaching the wheel axle 31A of the wheel 3A from the frame body 20A of the wheel frame 2A.

However, the elastic plate 1A is not made easily, thereby increasing costs of fabrication of the conventional hand cart.

### SUMMARY OF THE INVENTION

The primary objective of the present invention is to provide a hand cart that can reduce its working costs and enhance its quality of production.

Another objective of the present invention is to provide a hand cart, wherein the locking member and the elastic member are made easily and conveniently, thereby decreasing costs of fabrication.

A further objective of the present invention is to provide a hand cart, wherein when the wheel axle of the wheel is inserted into the frame body of the wheel frame, the first section of the locking member is inserted into and locked in the locking groove of the wheel axle automatically by the elastic force of the elastic member, so that the wheel axle of the wheel is mounted on the frame body of the wheel frame easily and rapidly.

A further objective of the present invention is to provide a hand cart, wherein the first section of the locking member is detached from the locking groove of the wheel axle by pressing the press button, so that the wheel axle of the wheel is detached from the frame body of the wheel frame easily and rapidly.

Further benefits and advantages of the present invention will become apparent after a careful reading of the detailed description with appropriate reference to the accompanying drawings.

### BRIEF DESCRIPTION OF THE DRAWINGS

FIG. 1 is a partially exploded perspective view of a hand cart in accordance with the preferred embodiment of the present invention;

FIG. 2 is a locally perspective enlarged view of the hand cart as shown in FIG. 1;

FIG. 3 is a plan cross-sectional assembly view of the hand cart as shown in FIG. 1;

FIG. 4 is a schematic operational view of the hand cart as shown in FIG. 3;

FIG. 5 is a perspective view of a golf cart in accordance with the preferred embodiment of the present invention;

FIG. 6 is a perspective view of a stroller in accordance with the preferred embodiment of the present invention;

FIG. 7 is an exploded perspective view of a conventional hand cart in accordance with the prior art; and

FIG. 8 is a plan cross-sectional assembly view of the conventional hand cart as shown in FIG. 7.

### DETAILED DESCRIPTION OF THE INVENTION

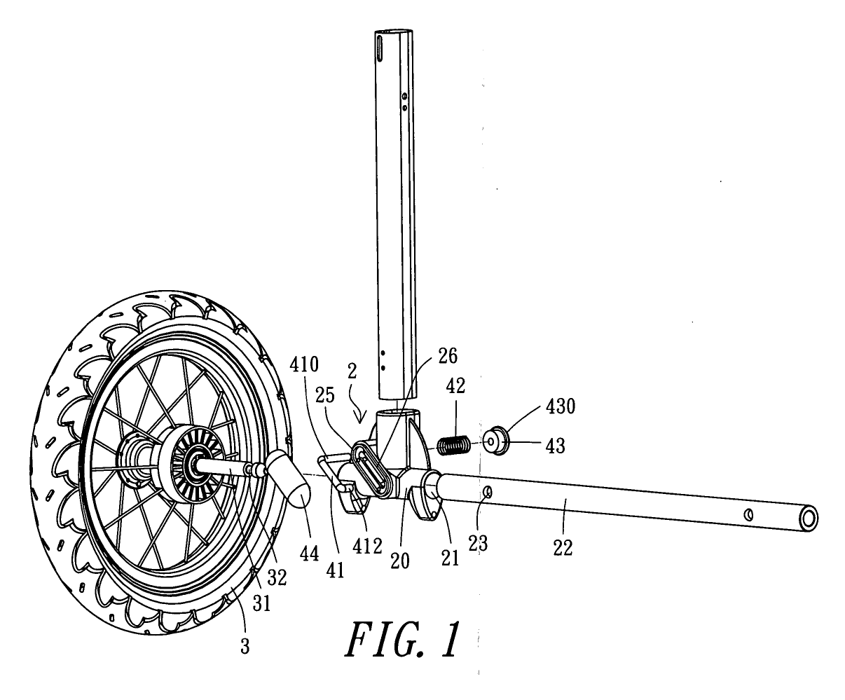

Referring to the drawings and initially to FIGS. 1-3, a hand cart in accordance with the preferred embodiment of the present invention comprises a wheel frame 2 having a frame body 20 formed with a mounting hole 21, a transverse rod 22 having an end portion mounted in the mounting hole 21 of the frame body 20 of the wheel frame 2, a wheel 3 having a wheel axle 31 mounted in the end portion of the transverse rod 22, and a quick release device 4 extended through the frame body 20 of the wheel frame 2 and the end portion of the transverse rod 22 and detachably locked onto the wheel axle 31 of the wheel 3 to detachably lock the wheel axle 31 of the wheel 3 and the end portion of the transverse rod 22 on the frame body 20 of the wheel frame 2.

The frame body 20 of the wheel frame 2 has a first side formed with a first through hole 26 communicating with the mounting hole 21 of the frame body 20 and a second side formed with a second through hole 25 located in parallel with the first through hole 26. The first through hole 26 of the frame body 20 has length smaller than that of the second through hole 25 of the frame body 20. The second through hole 25 of the frame body 20 has an end face formed with a stepped receiving recess 27.

The end portion of the transverse rod 22 is formed with a fixing hole 23 communicating with the first through hole 26 of the frame body 20.

The wheel axle 31 of the wheel 3 has an end portion formed with an annular locking groove 32 communicating with the fixing hole 23 of the transverse rod 22.

The quick release device 4 includes a locking member 41, a press button 43, an elastic member 42, and a cover 44.

The locking member 41 is movably mounted on the frame body 20 of the wheel frame 2. The locking member 41 is substantially U-shaped and has a first section 412 extended through the first through hole 26 of the frame body 20 and the fixing hole 23 of the transverse rod 22 and detachably locked in the locking groove 32 of the wheel axle 31 to lock the wheel axle 31 of the wheel 3 and the end portion of the transverse rod 22 on the frame body 20 of the wheel frame 2 and a second section 410 movably mounted in the second through hole 25 of the frame body 20. The first section 412 of the locking member 41 has a length smaller than that of the second section 410 of the locking member 41.

The press button 43 is movably mounted on the frame body 20 of the wheel frame 2 and secured on a distal end of the second section 410 of the locking member 41 for moving the second section 410 of the locking member 41. The press button 43 is movably mounted in the receiving recess 27 of the frame body 20 and has an enlarged head 430 protruded outward from the frame body 20 of the wheel frame 2.

The elastic member 42 is mounted on the second section 410 of the locking member 41 and biased between the frame body 20 of the wheel frame 2 and the press button 43 to push the press button 43 to move outward relative to the frame body 20 of the wheel frame 2 and to push the locking member 41 to move toward the frame body 20 of the wheel frame 2. The elastic member 42 is mounted in the receiving recess 27 of the frame body 20.

The cover 44 is mounted on the frame body 20 of the wheel frame 2 to cover the locking member 41 and to cover the first through hole 26 and the second through hole 25 of the frame body 20.

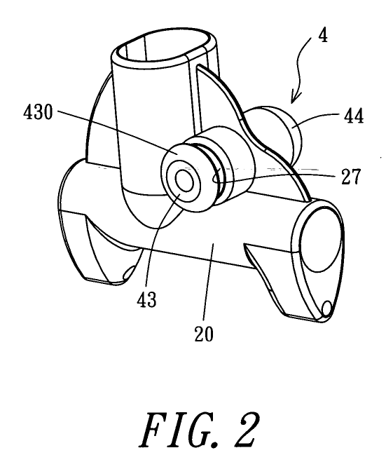

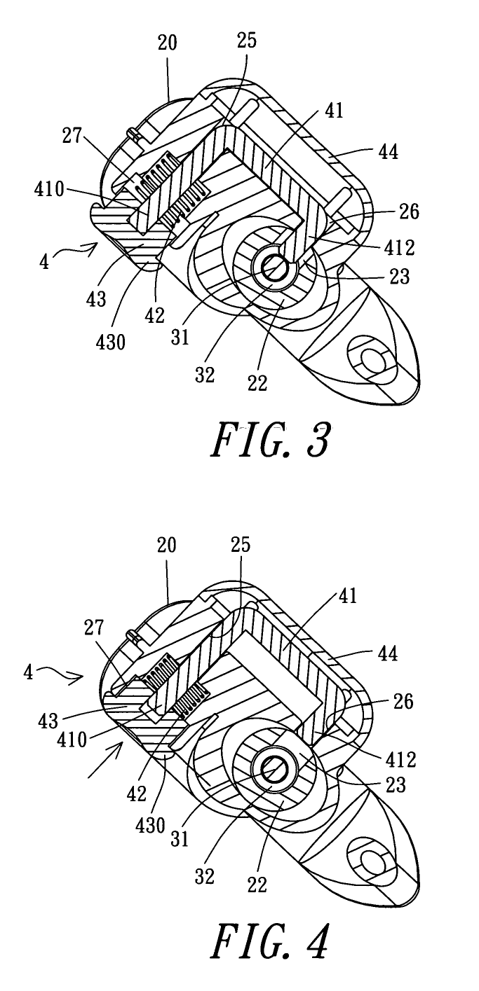

In operation, referring to FIG. 3 with reference to FIGS. 1 and 2, the elastic member 42 is biased between the frame body 20 of the wheel frame 2 and the press button 43 to push the press button 43 to move outward relative to the frame body 20 of the wheel frame 2 to drive the second section 410 of the locking member 41 to retract into the second through hole 25 of the frame body 20 and to drive the first section 412 of the locking member 41 to retract into the first through hole 26 of the frame body 20, so that the first section 412 of the locking member 41 is normally locked in the locking groove 32 of the wheel axle 31 by the elastic force of the elastic member 42 so as to lock the wheel axle 31 of the wheel 3 and the end portion of the transverse rod 22 on the frame body 20 of the wheel frame 2.

Alternatively, referring to FIG. 4 with reference to FIGS. 1 and 2, when the press button 43 is pushed to move toward the frame body 20 of the wheel frame 2 to overcome the elastic force of the elastic member 42, the second section 410 of the locking member 41 is pushed by the press button 43 to move outward relative to the frame body 20 of the wheel frame 2 and the first section 412 of the locking member 41 is pushed to move outward relative to the frame body 20 of the wheel frame 2, so that the first section 412 of the locking member 41 is detached from the locking groove 32 of the wheel axle 31 so as to unlock the wheel axle 31 of the wheel 3 from the frame body 20 of the wheel frame 2.

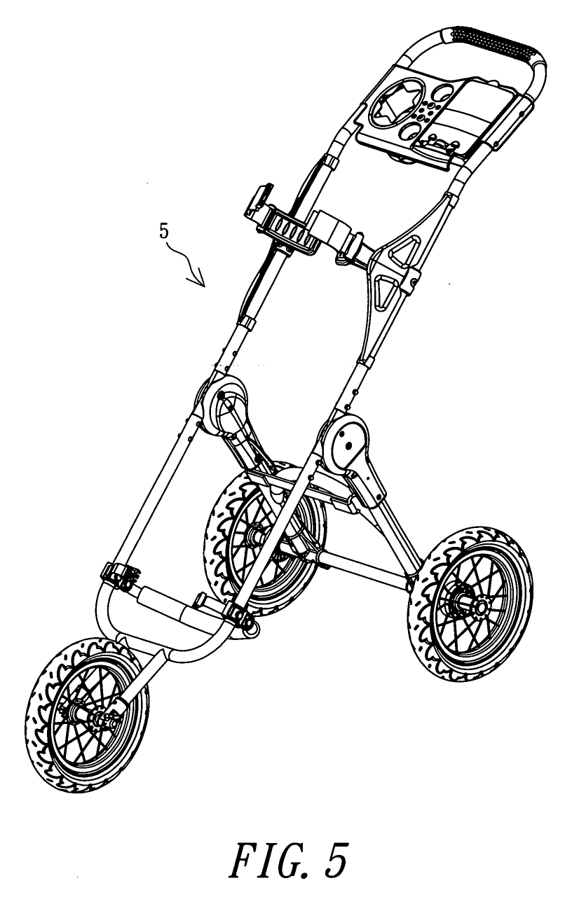

Referring to FIG. 5, the quick release device is used for a golf cart 5.

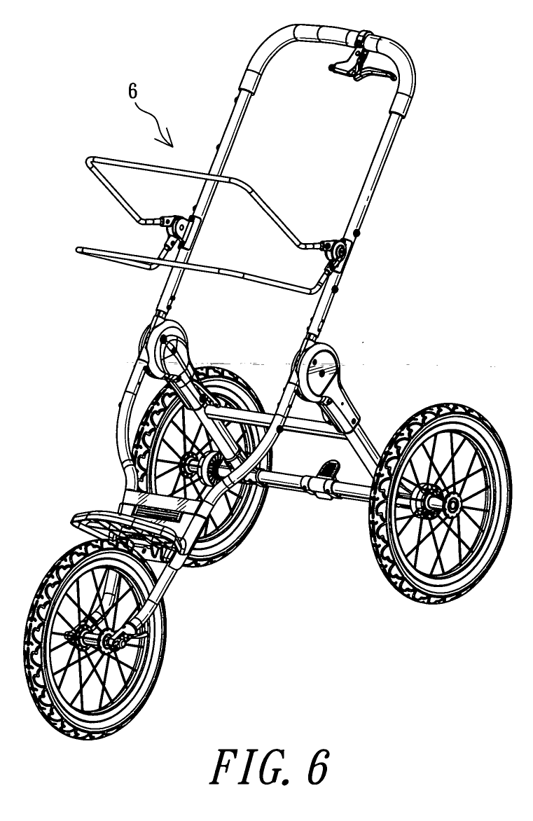

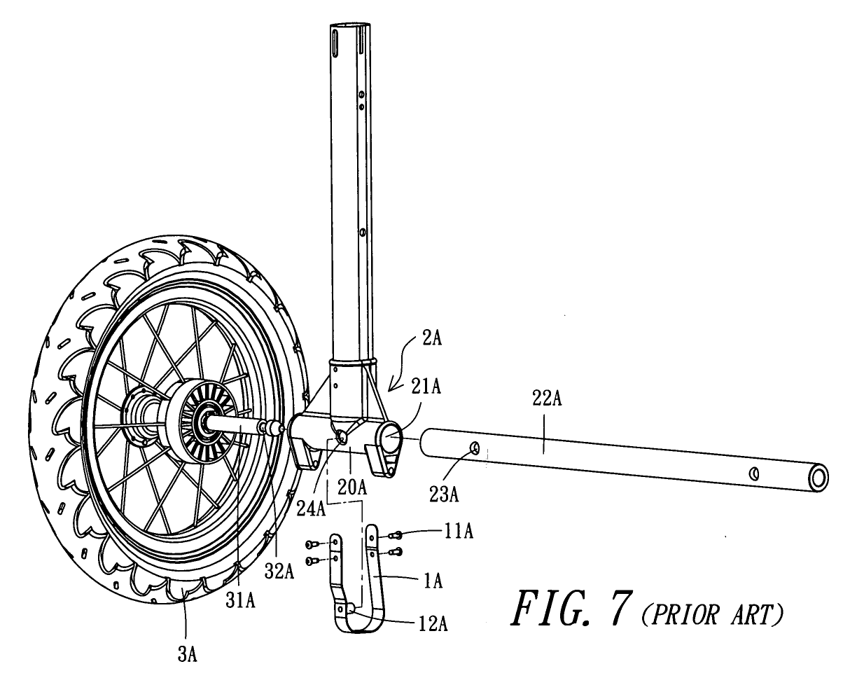

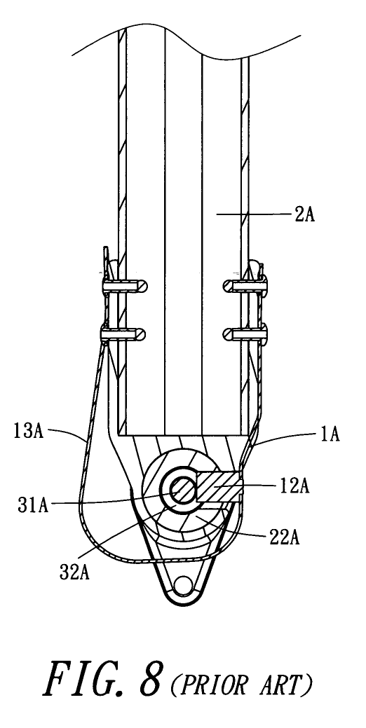

Referring to FIG. 6, the quick release device is used for a stroller 6.

Accordingly, when the wheel axle 31 of the wheel 3 is inserted into the frame body 20 of the wheel frame 2, the first section 412 of the locking member 41 is inserted into and locked in the locking groove 32 of the wheel axle 31 automatically by the elastic force of the elastic member 42, so that the wheel axle 31 of the wheel 3 is mounted on the frame body 20 of the wheel frame 2 easily and rapidly. In addition, the first section 412 of the locking member 41 is detached from the locking groove 32 of the wheel axle 31 by pressing the press button 43, so that the wheel axle 31 of the wheel 3 is detached from the frame body 20 of the wheel frame 2 easily and rapidly. Further, the locking member 41 and the elastic member 42 are made easily and conveniently, thereby decreasing costs of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A hand cart, comprising:
a wheel frame having a frame body formed with a mounting hole;
a transverse rod having an end portion mounted in the mounting hole of the frame body of the wheel frame;
a wheel having a wheel axle mounted in the end portion of the transverse rod;
a quick release device extended through the frame body of the wheel frame and the end portion of the transverse rod and detachably locked onto the wheel axle of the wheel to detachably lock the wheel axle of the wheel and the end portion of the transverse rod on the frame body of the wheel frame.

2. The hand cart in accordance with claim 1, wherein:
the frame body of the wheel frame has a first side formed with a first through hole communicating with the mounting hole of the frame body and a second side formed with a second through hole;
the end portion of the transverse rod is formed with a fixing hole communicating with the first through hole of the frame body;
the wheel axle of the wheel has an end portion formed with an annular locking groove communicating with the fixing hole of the transverse rod;
the quick release device includes a locking member having a first section extended through the first through hole of the frame body and the fixing hole of the transverse rod and detachably locked in the locking groove of the wheel axle to lock the wheel axle of the wheel and the end portion of the transverse rod on the frame body of the wheel frame and a second section movably mounted in the second through hole of the frame body.

3. The hand cart in accordance with claim 2, wherein the second through hole of the frame body is located in parallel with the first through hole.

4. The hand cart in accordance with claim 2, wherein the first through hole of the frame body has length smaller than that of the second through hole of the frame body.

5. The hand cart in accordance with claim 2, wherein the locking member is movably mounted on the frame body of the wheel frame.

6. The hand cart in accordance with claim 2, wherein the locking member is substantially U-shaped.

7. The hand cart in accordance with claim 2, wherein the first section of the locking member has a length smaller than that of the second section of the locking member.

8. The hand cart in accordance with claim 2, wherein the quick release device further includes a press button movably mounted on the frame body of the wheel frame and secured on a distal end of the second section of the locking member for moving the second section of the locking member.

9. The hand cart in accordance with claim 8, wherein the second through hole of the frame body has an end face formed with a stepped receiving recess, and the press button is movably mounted in the receiving recess of the frame body.

10. The hand cart in accordance with claim 8, wherein the press button has an enlarged head protruded outward from the frame body of the wheel frame.

11. The hand cart in accordance with claim 8, wherein the quick release device further includes an elastic member mounted on the second section of the locking member and biased between the frame body of the wheel frame and the press button to push the press button to move outward relative to the frame body of the wheel frame and to push the locking member to move toward the frame body of the wheel frame.

12. The hand cart in accordance with claim 11, wherein the second through hole of the frame body has an end face formed with a stepped receiving recess, and the elastic member is mounted in the receiving recess of the frame body.

13. The hand cart in accordance with claim 11, wherein the elastic member pushes the press button to move outward relative to the frame body of the wheel frame to drive the second section of the locking member to retract into the second through hole of the frame body and to drive the first section of the locking member to retract into the first through hole of the frame body, so that the first section of the locking member is normally locked in the locking groove of the wheel axle by the elastic force of the elastic member.

14. The hand cart in accordance with claim 13, wherein when the press button is pushed to move toward the frame body of the wheel frame to overcome the elastic force of the elastic member, the second section of the locking member is pushed by the press button to move outward relative to the frame body of the wheel frame and the first section of the locking member is pushed to move outward relative to the frame body of the wheel frame, so that the first section of the locking member is detached from the locking groove of the wheel axle.

15. The hand cart in accordance with claim 13, wherein when the wheel axle of the wheel is inserted into the frame body of the wheel frame, the first section of the locking member is inserted into and locked in the locking groove of the wheel axle automatically by the elastic force of the elastic member.

16. The hand cart in accordance with claim 1, wherein the quick release device further includes a cover mounted on the frame body of the wheel frame to cover the locking member and to cover the first through hole and the second through hole of the frame body.
